(19) United States
(12) Patent Application Publication
(10) Pub. No.: US 2013/0049978 A1
(43) Pub. Date: Feb. 28, 2013

(54) System and Method for Wireless Enrollment Using a Visual Status Indicator

(71) Applicants: Kevin G. Piel, Ronkonkoma, NY (US); Raymond J. Jordan, Holtsville, NY (US); Richard J. Laube, Holtsville, NY (US); Michael Garavuso, Lindenhurst, NY (US); Bertrand Jean Michel DeBever, Le Cannet (FR); Barry S. Masel, Forest Hills, NY (US)

(72) Inventors: Kevin G. Piel, Ronkonkoma, NY (US); Raymond J. Jordan, Holtsville, NY (US); Richard J. Laube, Holtsville, NY (US); Michael Garavuso, Lindenhurst, NY (US); Bertrand Jean Michel DeBever, Le Cannet (FR); Barry S. Masel, Forest Hills, NY (US)

(73) Assignee: Honeywell International Inc., Morristown, NJ (US)

(21) Appl. No.: 13/216,286

(22) Filed: Aug. 24, 2011

(51) Int. Cl. G08B 21/00

(52) U.S. Cl. 340/687

(57) ABSTRACT

A regional monitoring system includes wireless units, or detectors which can be associated with a displaced regional monitoring control element. Local feedback provided at the unit or detector for the installer. The units, or detectors can include all devices which can usefully be coupled to the monitoring control element. Examples, without limitation include all types of ambient condition detectors, motion detectors, location detectors, glass break detectors and the like. A light emitting diode carried by a respective unit can be activated to output a selected color when the unit has been successfully enrolled, and in communication with the monitoring control element.

### FIELD

The application pertains to systems and methods to facilitate the installation of sensors or detectors in wireless regional monitoring systems. More particularly, the application pertains to such systems and methods which provide positive feedback that a given sensor or detector has been successfully installed and is communicating with a control unit of a monitoring system.

### BACKGROUND

Regional monitoring systems often include input devices, such as keypads, or various types of detectors, such as motion detectors, glass break detectors, smoke or gas detectors which are displaced from a common control unit or panel. Communications between the units and the panel may be wired or wireless. Wireless devices present challenges to installers not necessarily present with wired devices.

On installation, the installer will usually need to incorporate, or enroll, the unit into or with the list of units known to the panel. Additionally, operational communications between the unit and panel need to be confirmed if it becomes necessary to carry out a maintenance procedure. Appropriate feedback needs to be provided to the installer, at the unit, to avoid having him/her having to go to a displaced keypad, or computer during the installation, or at the end of the maintenance process.

### BRIEF DESCRIPTION OF THE DRAWING

FIG. 1 is a block diagram of a system in accordance herewith.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

In accordance herewith, wireless units, or detectors can be associated with a displaced regional monitoring control element. Local feedback can be provided at the unit or detector for the installer. The class of units, or detectors can include all devices which can usefully be coupled to the monitoring control element. Examples, without limitation include all types of ambient condition detectors, motion detectors, location detectors, glass break detectors and the like,

Such devices can be equipped with a multi-color light emitting device. For example, multi-color LED-type output devices could be used.

When the device is initially powered-up, a first color, red for example, could be emitted. Once the enrollment process has been successfully concluded, with a displaced monitoring control element, or, panel, the color could be changed to blue or green as an indicium of the successful enrollment and functioning of the unit. To extend battery life, device illumination, or color changes could be implemented for limited time periods.

If the unit had previously been installed, and was exhibiting a blue or green visual output, it might have to be taken off-line, for example to replace a battery. When the unit is powered-up again, the first color could be emitted again until the unit has once again been brought back on-line. Battery replacement need not break the enrollment with the panel.

Advantageously, other maintenance and operational functions can be provided using the same multi-color output device. It will be understood that in addition to emitting various colors, both frequency and duty cycle parameters can be varied to indicate status or other conditions.

Status indicators, based on an illuminatable LED, could include:

| Peripheral status | | Suggestion for LED |
|---|---|---|
| Peripheral Powered but “Virgin” | | LED flash every 15 |
| (never enrolled before) | | seconds |
| Peripheral Powered, enrolled | | LED OFF |
| Peripheral during walk test mode | | LED flash for each |
| | | sensor solicitation |
| Peripheral in Maintenance | Battery OK | One flash every second |
| mode, when in synch with a | Battery KO | two flashes every second |
| beacon. | | |

Those of skill in the art will understand that the above enumeration is exemplary only, and not limited.

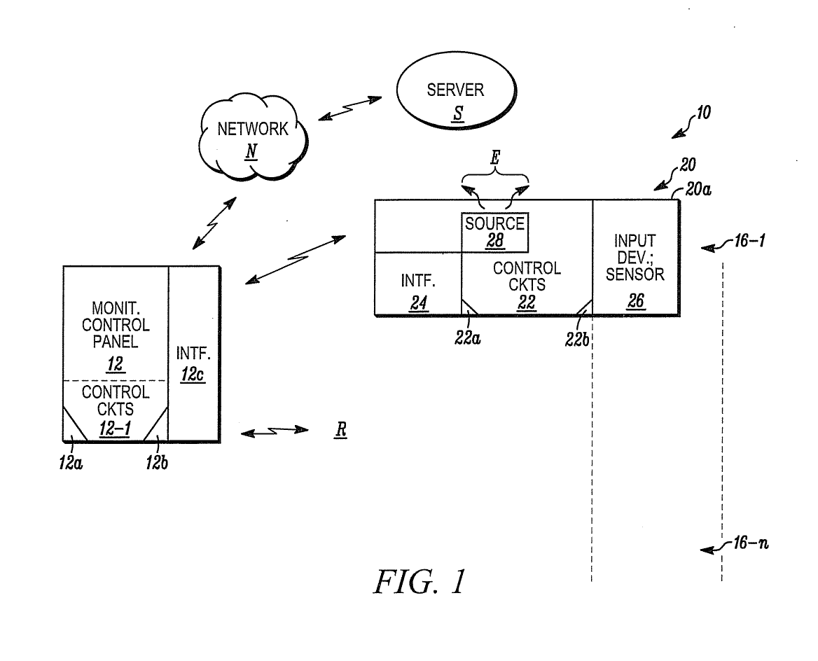

FIG. 1 illustrates an apparatus 10 in accordance herewith. Apparatus 10 is a regional monitoring/security system which monitors conditions in a region R. It includes a monitoring/control panel 12. Panel 12 can be implemented at least in part by control circuits 12-1. Circuits 12-1 can include one or more programmable processors 12a which execute stored control software 12b. Panel 12 can include wired or wireless interfaces 12c for communications with various types of sensors or detectors, all without limitation. It will also be understood that panel 12 could also be in wireless communication with a displaced server S via a computer network N.

A plurality of units 16-1, -2, -3 . . . -n can be in wireless communication with the panel 12. Unit 16-1 is representative thereof and a discussion of it will also apply to other members of the plurality.

Unit 16-1 includes a housing 20 having an exterior peripheral surface 20a. Housing 20, which could be hollow, carries control circuits 22. Control circuits 22 can be implemented, at least in part, with a programmable processor 22a, which executes pre-stored control software 22b. Circuits 22 are coupled to a bidirectional wireless interface 24. The unit 16-1 is in wireless communication with the panel 12 via the interface 24.

Unit 16-1 carries at least one of an input device, for example a keypad, or a condition sensor 26. Sensor 26 could include one or more of a location sensor, a movement sensor, a glass break sensor, a smoke sensor, a thermal sensor, a gas sensor all without limitation.

Unit 16-1 also carries a multi-color, visual light emitting device 28 coupled to control circuits 22. The device 28 is configured to emit visible radiant energy E from the housing 20. For example, device 28 could be implemented with a multi-color LED, without limitation.

When the unit 16-1 is initially powered-up, a first color, red for example, could be emitted via the output device 28. Once the enrollment process has been successfully concluded, with the monitoring control element, or, panel, 12 the color emitted from device 28 could be changed to blue or green as an indicium of the successful enrollment and functioning of the unit 16-1.

If the unit 16-1 had previously been installed, and was exhibiting a blue or green visual output, it might have to be taken off-line, for example to replace a battery. When the unit 16-1 is powered-up again, the color red could be emitted again until the unit 16-1 has once again been brought back on-line or enrolled with the pane 12.

Other condition, or status information can be provided via visual source 28 to a local installer. Examples were discussed above in paragraph number 11. For example, based on color of emitted light from source 28, in combination with flash rate and/or duty cycle, a maintenance mode can be indicated, a walk test mode can be indicated and status information can be provided that the unit has been powered but never previously enrolled. Other variations come within the spirit and scope hereof.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. An apparatus comprising:
a unit having
a housing with an exterior peripheral surface;
at least one of an input device, or a condition sensor carried by the housing;
control circuits coupled to the input device or the sensor; and
a communications interface carried by the housing, coupled to the control circuits, a light emitting output device which emits at least first and second viewable output indicia where at least one indicium is indicative of an acceptable communication state relative to a displaced monitoring control element in response to a communication received via the interface, and a second is indicative of a different condition, and where the indicia are directed away from the external peripheral surface.

2. An apparatus as in claim 1 wherein the output device comprises a multi-color, visible light emitting device.

3. An apparatus as in claim 2 wherein the control circuits vary a parameter associated with the light emitting output device which includes at least one of emitted color, illumination rate, or duty cycle in response to a communication received via the interface.

4. An apparatus as in claim 1 which includes a displaced monitoring control element which communicates with the unit.

5. An apparatus as in claim 4 wherein the control circuits vary a parameter associated with the light emitting output device which includes at least one of emitted color, illumination rate, or duty cycle in response to a communication received via the interface.

6. An apparatus as in claim 5 wherein the control circuits vary the parameter in response to the monitoring control element having enrolled the unit.

7. An apparatus as in claim 6 where the sensor is selected from a class which includes a position sensor, a motion sensor, a glass break detector, a smoke detector, a fire detector, or a gas detector.

8. An apparatus as in claim 6 which includes a plurality of units which communicate with the control element, wherein at least some of the units include circuitry responsive to at least one of a loss of enrollment, or a loss of communications with the control element, to vary the parameter to emit the second indicium.

9. An apparatus as in claim 8 where a loss of one of communications, or enrollment is indicated at a respective unit by a change from a first emitted color to a second emitted color.

10. A method comprising:
providing a recipient with information from a plurality of displaced units;
evaluating at least some of the information, and responsive to an enrollment request from at least one unit, determining if a successful enrollment has taken place; and
responsive to the determining, where a successful enrollment of a selected unit has taken place, transmitting a message to the unit to visually indicate the successful enrollment.

11. A method as in claim 10 where visually indicating includes providing a visual output by varying at least one of emitted color, illumination rate, or duty cycle in response to receiving the message.

12. A method as in claim 11 which includes providing a different visual output, in response to a local condition.

13. A method as in claim 12 where the different visual output includes at least one of providing illuminating control signals which activate different visual output rates, which activate different colors, or which activate both different rates and colors.

14. A regional monitoring system comprising:
a monitoring control panel which includes control circuits and a wireless communications interface;
a plurality of units, displaced from the panel and in wireless communication therewith, the units each include local control circuits, and at least one local visual output device coupled thereto, wherein, in response to each of the units being enrolled by the control panel, the respective visual output device emits a predetermined enrollment indicium.

15. A system as in claim 14 wherein the enrollment indicium comprises at least one of light of a selected color, light output at a selected intermittent rate, or of a selected duty cycle.

16. A system as in claim 15 where emitted light from a respective visual output device comprises a different status indictor.
